(19) United States
(12) Patent Application Publication
(10) Pub. No.: US 2017/0008188 A1
(43) Pub. Date: Jan. 12, 2017

(54) CUTTING APPARATUS

(71) Applicant: JUSTIN STAFFEN, Alberta (CA)

(72) Inventor: JUSTIN STAFFEN, Alberta (CA)

(21) Appl. No.: 14/796,373

(22) Filed: Jul. 10, 2015

(51) Int. Cl. B27B 5/18; B27B 5/02; B26D 7/22

(52) U.S. Cl. CPC B27B 5/187; B26D 7/22; B27B 5/02

(57) ABSTRACT

A cutting apparatus can include a frame, a carriage, a saw, and a post. The frame can have a first height defined along a vertically-extending height axis between a first bottom end and a first top end. The carriage can be mounted on the frame for adjustable positioning relative to the frame along the height axis. The carriage can include a first aperture positioned with the frame and defining a cutting plane. The saw can be mounted on the carriage within the frame for sliding movement across the first aperture. The post can be mounted on the carriage. The post can have a second height defined along the height axis between a second bottom end and a second top end. The post can extend along the height axis above the first top end.

### BACKGROUND

1. Field

The present disclosure relates to machines for penetrating material by means of a solid tool which applies mechanical deforming force to the material by direct physical contact therewith.

2. Description of Related Prior Art

U.S. Pat. No. 4,885,967 discloses a Laser alignment device for sawmills. The laser alignment device can be detachably mounted on a lumber cutting machine for assisting an operator in properly aligning a workpiece before cutting it into strips of desired widths. The device includes a frame which supports laser devices for projecting cutting-lines on the workpiece, which are visible to the operator. The laser devices are movable on the frame and their positions may be adjusted independent of each other so as to be in alignment with the respective saw blades disposed within the lumber cutting machine. The device further includes devices for locking the desired positions of the laser devices on the frame.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A cutting apparatus can include a frame, a carriage, a saw, and a post. The frame can have a first height defined along a vertically-extending height axis between a first bottom end and a first top end. The carriage can be mounted on the frame for adjustable positioning relative to the frame along the height axis. The carriage can include a first aperture positioned with the frame and defining a cutting plane. The saw can be mounted on the carriage within the frame for sliding movement across the first aperture. The post can be mounted on the carriage. The post can have a second height defined along the height axis between a second bottom end and a second top end. The post can extend along the height axis above the first top end.

### BRIEF DESCRIPTION OF THE DRAWINGS

The detailed description set forth below references the following drawings:

FIG. 1 is a perspective view of a cutting apparatus according to an exemplary embodiment of the present disclosure in an exemplary operating environment;

FIG. 2 is a perspective view of a cutting apparatus according to an exemplary embodiment of the present disclosure;

FIG. 3 is a perspective view of the cutting apparatus shown in FIG. 2;

FIG. 4 is a view of a cutting plane in one or more embodiments of the present disclosure; and

FIG. 5 is a partial cross-section taken along section line 5 in FIG. 2.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide an improvement for cutting stakes at a specific elevation on a worksite. Known methods are extremely dangerous and require multiple tradesman to execute properly. The present disclosure provides an apparatus allowing a single tradesman to safely perform three operations easily. Prior methods were very strenuous as the tradesman was bent over for extended periods of time operating a saw at his ankles to cut stakes with very little accuracy. Two other tradesman used a laser to mark all the stakes ahead of the tradesman doing the cutting. When the tradesman doing the cutting finished, the stake waste piece would sometimes fall on to the still rotating blade and be deflected outward and would often strike the shins of the tradesman doing the cutting or other workers nearby. The exemplary embodiment can be wrapped in an expanded metal sheeting which acts as a guard to eliminate all existing hazards.

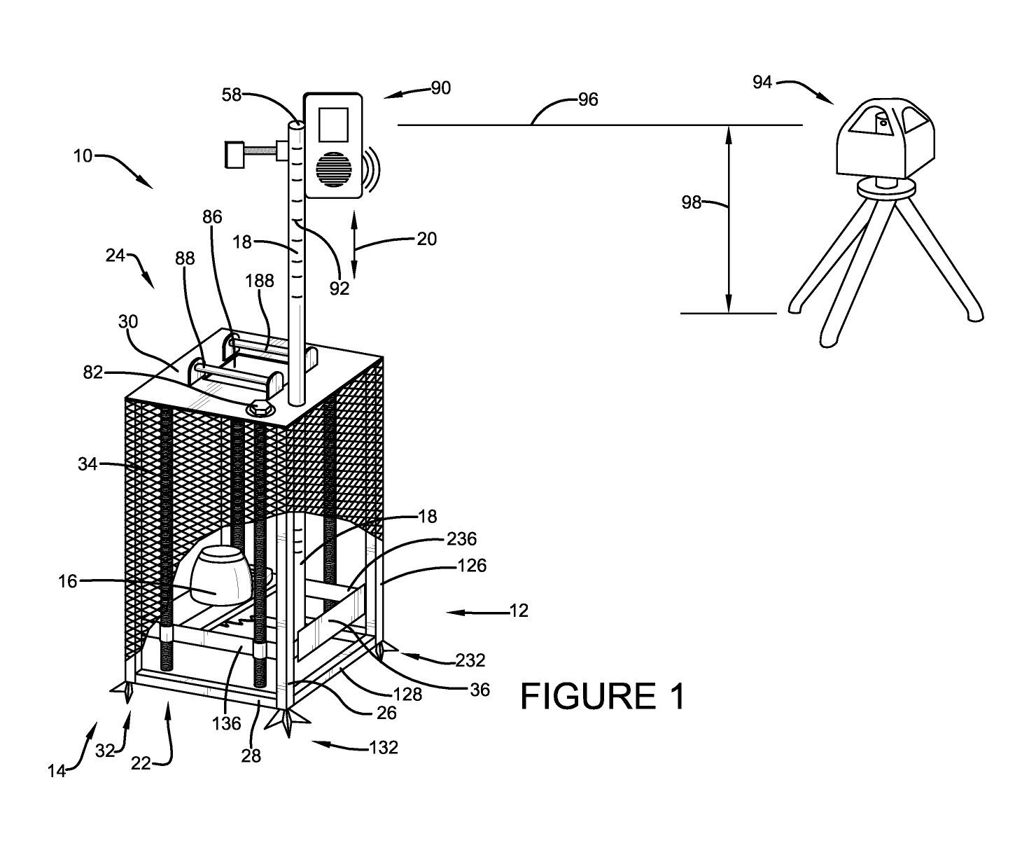

Referring now to FIG. 1, a cutting apparatus 10 can include a frame 12, a carriage 14, a saw 16, and a post 18. The frame 12 can have a first height defined along a vertically-extending height axis 20 between a first bottom end 22 and a first top end 24. The exemplary frame 12 can include vertical members 26, 126 and horizontal members 28, 128 interconnected with one another.

The exemplary frame 12 can also include an enclosing plate 30 at the first top end 24 and at least partially enclosing an inner cavity defined by the frame 12. The exemplary frame 12 can also include feet, such as foot 32, 132, 232, at the first bottom end 22. The feet 32, 132, 232 can include a downward, pointed portion to more easily pierce the ground and can project outward from the rest of the frame 12 to define a landing for feet to press the pointed portion into the ground.

A screen 34 can be interconnected with the vertical members 26, 126 and horizontal members 28, 128 to enclose the inner cavity defined by the frame 12. In the exemplary embodiment, the screen 34 can cover three sides of the frame 12. In FIG. 1, a portion of the screen 34 has been cut-away to reveal the inner cavity defined by the frame 12.

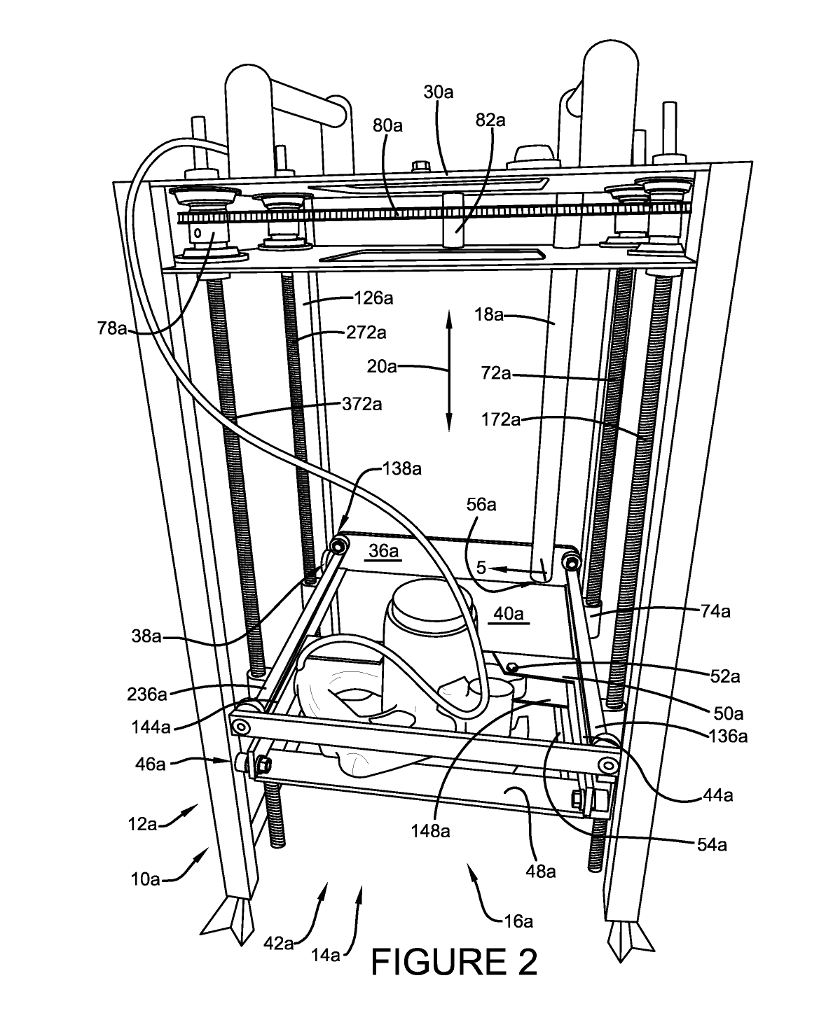

The carriage 14 can be mounted on the frame 12 for adjustable positioning relative to the frame 12 along the height axis 20. The exemplary carriage 14 can include horizontal members, such horizontal members 36, 136, 236. One or more rollers can be mounted on the carriage 14 to guide movement of the carriage 14 relative to the frame 12. Referring now to another embodiment of the present disclosure shown in FIG. 2, a first roller 38a can be disposed for rotation about a first axis and a second roller 138a can be disposed for rotation about a second axis that is transverse to the first axis. Rollers like rollers 38a and 138a can be positioned at each corner of the carriage 14a.

The carriage 14a can include a first aperture 40a positioned with the frame 12a and defining a cutting plane. The first aperture 40a can be defined in part by the horizontal members 36a, 136a, and 236a. The saw 16a can be mounted on the carriage 14a within the frame 12a for sliding movement across the first aperture 40a.

The cutting apparatus 10a can include a truck 42a mounted on the carriage 14a for sliding movement transverse to the height axis 20a. The saw 16a can be mounted on the truck 42a. The truck 42a can include horizontal side members 44a, 144a.Rollers such as roller 46a can be mounted on the horizontal side members 44a, 144a and the horizontal members 136a and 236a of the carriage 14a can define tracks receiving the rollers mounted on the truck 42a. The truck 42a can also include horizontal bottom members 48a, 148a. The saw 16a can rest on the horizontal bottom members 48a, 148a.

The truck 42a can also include horizontal top member 50a. The top member 50a and the bottom member 148a can cooperate to define a pocket receiving a portion of the saw 16a. The top member 50a and the bottom member 148a can thus cooperate to secure the saw 16a in place. A set screw 52a can extend through the top member 50a to further enhance securing the saw 16a in place.

One or both of the top member 50a and the bottom member 148a can cooperate with the horizontal members 36a, 136a, 236a of the carriage 14a to define the first aperture 40a. Since the truck 42a is moveable relative to the horizontal members 36a, 136a, 236a, the size of the first aperture 40a is thus variable. The cutting apparatus 10a can also include a biasing device urging the truck 42a to a first side of the carriage 14a and thus maximizing the size of the first aperture 40a. In the exemplary embodiment, the biasing device can be an elastic or “bungee” cord 54a interconnected to the member 148a and the carriage 14a (connection not shown).

Referring again to FIG. 1, the post 18 can be mounted on the carriage 14. The exemplary post 18 can be mounted to the member 36 of the carriage 14. The post 18 can have a second height defined along the height axis 20 between a second bottom end (referenced at 56a in FIGS. 2 and 5) and a second top end 58. The post 18 can extend along the height axis 20 above the first top end 24. In the exemplary embodiment, the second top end 58 can always be above the first top end 24.

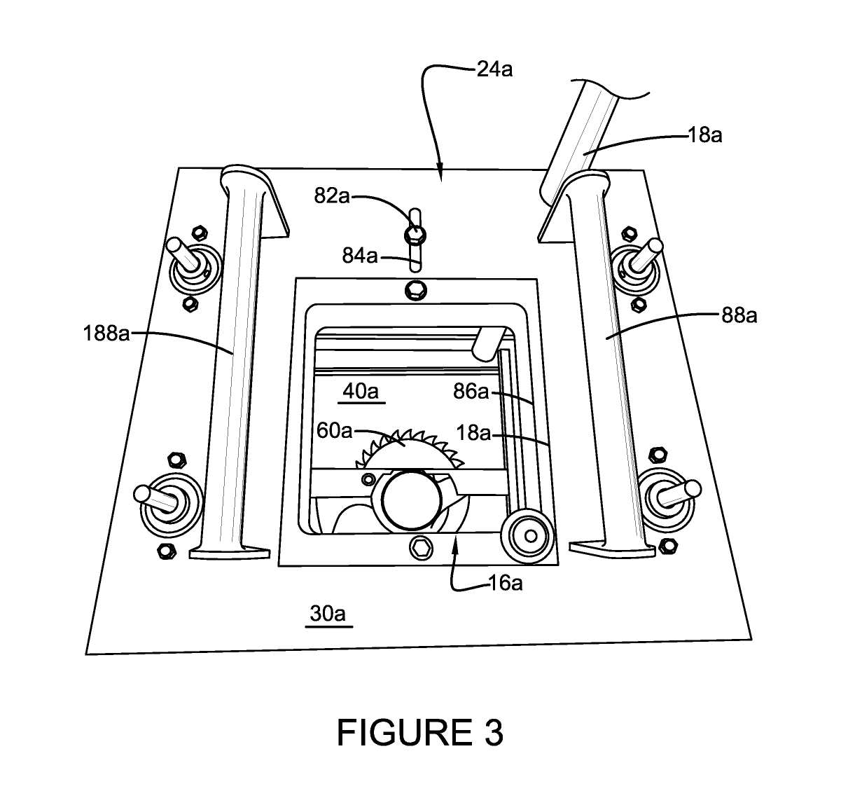

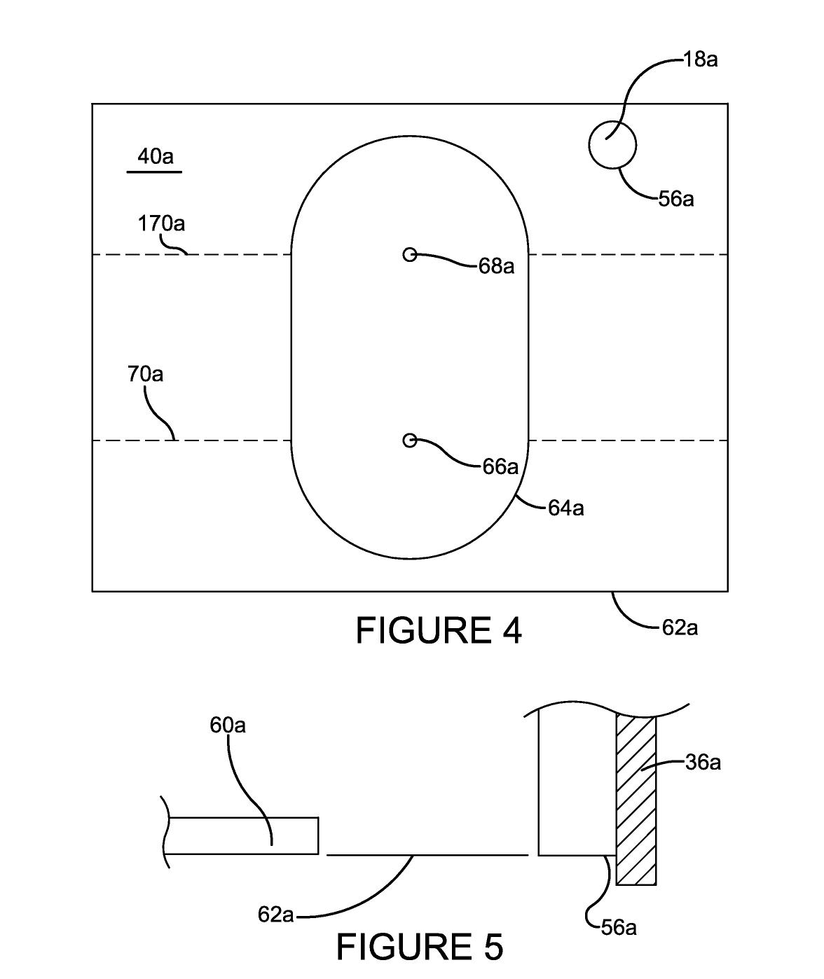

Referring now to FIG. 3, the saw 16a can also include a saw blade 60a. The saw blade 60a can define a swath in the cutting plane during movement of the saw 16a across the first aperture 40a. FIG. 4 illustrates the exemplary cutting plane 62a. The first aperture 40a can be coplanar with the cutting plane 62a. The swath of the saw blade 60a is referenced at 64a. The point 66a can be the center of rotation of the saw blade 16a when the truck 42a is at a first end limit of travel. The point 68a can be the center of rotation of the saw blade 16a when the truck 42a is at a second end limit of travel. A first dashed line referenced at 70a can define a boundary of the first aperture 40a when the truck 42a is at the first end limit of travel. A second dashed line referenced at 170a can define a boundary of the first aperture 40a when the truck 42a is at the second end limit of travel. The second bottom end 56a of the post 18a can be positioned outside of and be coplanar with the swath 64a, as illustrated by FIGS. 4 and 5. FIG. 5 illustrates the bottom end 56a of the post 18a substantially aligned with the cutting plane 62a.

Referring again to FIG. 2, the cutting apparatus 10a can further include a plurality of drive members 72a, 172a, 272a, 372a engaged with the carriage 14a to drive the carriage 14a in movement along the height axis 20a. At least one of the plurality of drive members 72a, 172a, 272a, 372a can be a worm supported for free rotation by the frame 12a and be engaged with the carriage 14a to drive the carriage 14a in movement along the height axis 20a during the rotation.

In the exemplary embodiment, all of the plurality of drive members 72a, 172a, 272a, 372a can be worms supported for free rotation by the frame 12a. Each of the plurality of drive members 72a, 172a, 272a, 372a can be supported for rotation by bearings disposed between the plurality of drive members 72a, 172a, 272a, 372a and the frame 12a. Respective top ends of the plurality of drive members 72a, 172a, 272a, 372a can be mounted to the enclosing plate 30a to freely rotate. In the exemplary embodiment, all of the plurality of drive members 72a, 172a, 272a, 372a can be engaged with the carriage 14a through threaded apertures in bosses, such as boss 74a having a threaded aperture. Bosses can be mounted on the horizontal members 136a and 236a. Each of the plurality of drive members 72a, 172a, 272a, 372a can be threaded and be received in a boss having a threaded aperture and mounted on the carriage 14a.

The cutting apparatus 10a can also include a transmission arrangement 76a having a plurality of outputs each respectively engaged with one of the plurality of drive members 72a, 172a, 272a, 372a whereby the plurality of drive members operate concurrently. The transmission arrangement 76a can include a plurality of sprockets each engaged with one of the plurality of drive members 72a, 172a, 272a, 372a. An exemplary socket is referenced at 78a. A sprocket can be mounted on each of the plurality of drive members 72a, 172a, 272a, 372a.

The transmission arrangement 76 can also include a chain 80a. The chain 80a can be engaged with each of the plurality of sprockets to concurrent drive all of the plurality of sprockets and thus concurrently drive all of the plurality of drive members 72a, 172a, 272a, 372a. The transmission arrangement 76 can also include a single input. In the exemplary embodiment, the single input can be a pin 82a. A sprocket can be mounted on the pin 82a and the chain 80a can be engaged with the sprocket mounted on the pin 82a. The pin 82a can be mounted to the enclosing plate 30a to freely rotate. The pin 82a can extend through the enclosing plate 30a and be exposed above the enclosing plate 30a. A top of the pin 82a can have a hex shape or other non-round shape to accommodate engagement with a driving tool such as a drill. As best shown in FIG. 3, the pin 82a can extend through a slot 84a in the enclosing plate 30a to allow the chain 80a to be adjustably tensioned.

When the pin 82a is rotated in a first angular direction, the plurality of drive members 72a, 172a, 272a, 372a can be driven in rotation by the transmission arrangement 76a and can urge the carriage 14a upwardly along the height axis 20a. When the pin 82a is rotated in a second angular direction opposition to the first angular direction, the plurality of drive members 72a, 172a, 272a, 372a can be driven in rotation by the transmission arrangement 76a and can urge the carriage 14a downwardly along the height axis 20a.

Referring again to FIG. 3, the frame 12a can also include a second aperture 86a in the first top end 24a, spaced from the post 18. The second aperture 86a can be substantially centered in the first top end 24a. The second aperture 86a can occupy one quarter, one third, one half of the first top end 24a or any percentage of the first top end 24a. The frame 12a can also include first and second handles 88a, 188a mounted on the first top end 24a on opposite sides of the second aperture 86a.

Referring again to FIG. 1, a laser receiver 90 can be mounted proximate to the second top end 58 of the post 18a and positioned above the first top end 24. The laser receiver 90 can be configured to detect a laser and emit an audible signal in response to detection of the laser. A Hilti™ Model 2071121 PRA 20 Rotating Laser Receiver can utilized in one or more embodiments of the present disclosure. The laser receiver 90 can be adjustably positionable along the height of the post 18a. The post 18 can include dimensional indicia 92 along a least a portion of its height to position the laser receiver 90 a desired distance from the bottom end 56a.

In operation, one or more stakes may be driven in the ground at a worksite. A rotating laser 94 can positioned at the worksite and emit a laser beam 96 at a desired elevation 98. The cutting apparatus 10 can be grasped by the handles 88, 188 by a tradesman and placed over a stake such that the stake is directed through the first aperture (referenced at 40a in FIGS. 2 and 3). The tradesman can view the placement of the frame 12 relative to the stake through the second aperture 86. The tradesman can then steady the frame 12 by stepping on the feet 32, 132, 232. It is noted that one or more embodiments of the present disclosure can include a leveling device for ensuring that the enclosing plate 30 (and thus the entire device 10) is level. The leveling device can be a “fish eye” level that can confirm that the device 10 is level along multiple axes.

If the laser receiver 90 is not emitting the audible signal indicating detection of the laser beam 96, the tradesman can then adjust the position of the laser receiver 90 by moving the carriage 14. The tradesman can use a driving tool such as a drill and rotate the pin 82 with the drill until the laser receiver 90 emits the audible signal indicating detection of the laser beam 96. The tradesman can then activate the saw 16 to rotate the saw blade (referenced at 60a in FIG. 3). The tradesman can then move the truck (referenced at 42a in FIG. 2) from the first end limit of travel, against the biasing force provided by the cord (referenced at 54a in FIG. 2). The tradesman can move the truck (referenced at 42a in FIG. 2) to the second end limit of travel, thus trimming the stake to a desired height. The cord (referenced at 54a in FIG. 2) can then urge the truck (referenced at 42a in FIG. 2) back to the first end limit of travel.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A cutting apparatus comprising:
a frame having a first height defined along a vertically-extending height axis between a first bottom end and a first top end;
a carriage mounted on said frame for adjustable positioning relative to said frame along said height axis, wherein said carriage includes a first aperture positioned with said frame and defining a cutting plane;
a saw mounted on said carriage within said frame for sliding movement across said first aperture; and
a post mounted on said carriage, having a second height defined along said height axis between a second bottom end and a second top end, and extending along said height axis above said first top end.

2. The cutting apparatus of claim 1 wherein said bottom end of said post is substantially aligned with said cutting plane.

3. The cutting apparatus of claim 1 wherein said saw further comprises:
a saw blade defining a swath in said cutting plane during movement of said saw across said first aperture, wherein said second bottom end of said post is positioned outside of and coplanar with said swath.

4. The cutting apparatus of claim 1 wherein said post further comprises:
dimensional indicia along a least a portion of said second height.

5. The cutting apparatus of claim 1 further comprising:
at least one worm supported for free rotation by said frame and engaged with said carriage to drive said carriage in movement along said height axis during the rotation.

6. The cutting apparatus of claim 1 further comprising:
a plurality of drive members engaged with said carriage to drive said carriage in movement along said height axis.

7. The cutting apparatus of claim 6 further comprising:
a transmission arrangement having a plurality of outputs each respectively engaged with one of said plurality of drive members whereby said plurality of drive members operate concurrently.

8. The cutting apparatus of claim 7 wherein said transmission arrangement includes a single input.

9. The cutting apparatus of claim 8 wherein said single input is positioned at said first top end of said frame.

10. The cutting apparatus of claim 7 wherein said plurality of drive members are worms.

11. The cutting apparatus of claim 10 wherein said transmission arrangement further comprises:
a plurality of sprockets each engaged with one of said plurality of drive members.

12. The cutting apparatus of claim 11 wherein said transmission arrangement further comprises:
a chain engaged with each of said plurality of sprockets.

13. The cutting apparatus of claim 1 further comprising:
a truck mounted on said carriage for sliding movement transverse to said height axis, said saw mounted on said truck.

14. The cutting apparatus of claim 13 further comprising:
a biasing device urging said truck to a first side of the carriage.

15. The cutting apparatus of claim 1 further comprising:
at least one roller mounted on said carriage and contacting said frame.

16. The cutting apparatus of claim 15 wherein said at least one roller is further defined as:
a first roller disposed for rotation about a first axis; and
a second roller disposed for rotation about a second axis transverse to said first axis.

17. The cutting apparatus of claim 1 wherein said frame further comprises:
a second aperture in said first top end spaced from said post.

18. The cutting apparatus of claim 17 wherein said second aperture is substantially centered in said first top end.

19. The cutting apparatus of claim 17 wherein said frame further comprises:
first and second handles mounted on said first top end on opposite sides of said second aperture.

20. The cutting apparatus of claim 1 further comprising:
a laser receiver mounted proximate to said second top end and positioned above said first top end, said laser receiver configured to detect a laser and emit an audible signal in response to detection of the laser.
